(19) United States
(12) Patent Application Publication
(10) Pub. No.: US 2018/0113418 A1
(43) Pub. Date: Apr. 26, 2018

(54) POSITIONAL TRACKING SYSTEM WITH HOLOGRAPHIC ENCODED POSITIONS

(71) Applicant: Sony Interactive Entertainment Inc., Tokyo (JP)

(72) Inventor: Jeffrey R. Stafford, San Mateo, CA (US)

(21) Appl. No.: 15/299,178

(22) Filed: Oct. 20, 2016

(51) Int. Cl. G03H 1/00; G03H 1/04; G06K 1/12

(52) U.S. Cl. CPC G03H 1/0005; G03H 1/041; G03H 1/0465; G03H 1/0486; G03H 2001/0224; G03H 2001/0413; G03H 2001/0415; G03H 2210/53; G06K 1/121

(57) ABSTRACT

An emitter laser illuminates multiple reflectors each of which produces a unique robust code, with the laser being sequentially moved between illuminating successive reflectors. The reflectors send light to a holographic film, and the laser poses can be associated with the respective codes. Subsequently, an illuminator such as another laser can illuminate the film, and a sensor positioned near the film records what code is produced, so that the code can be correlated to a laser pose with respect to the film and sensor.

### FIELD

The application relates generally to positional tracking systems with holographic encoded positions.

### BACKGROUND

Many applications benefit from knowing the relative location of an object such as a virtual reality (VR) or augmented realty (AR) headset relative to an object such as a display. Computer games for instance, can benefit from knowing such locations.

### SUMMARY

A system records a hologram of an array of position encodings onto photographic film (holographic film) to be read by a digital or analog sensor (charge coupled device (CCD), complementary metal-oxide semiconductor (CMOS), photodiodes, etc.). The position of the laser source used for the recording of the hologram is encoded into the holographic film as a reflection of its light onto a series of objects used to encode the physical position of the laser source relative to the film. The encoding onto the hologram can be a simple series of bars, splotches, lines, bar codes, QR codes, or any form of noise robust image based encoding scheme to encoding one or more values representing the relative Azimuth angle A, Bearing angle B, Roll angle R, X position, Y position, Z position, or any combination of angles and positions to form one, two or three dimensions of positions and angles of the laser source. These encodings represent the relative pose of the laser source to the holographic film.

A mechanized system can move a laser source and a series of position encoding object reflectors such that for each position of the laser emitter, a different encoding object reflection is recorded into one or more areas on the holographic film. The object reflectors are positioned to reflect an image based encoding of one or more pose values. The pose value(s) are a ground truth measurement of the laser source relative to the holographic film. The mechanized system moves the laser light source and the pose encoding reflector objects over a 1D, 2D or 3D array of positions to record the positional spacing and/or relative angles of the laser source into the holographic film.

A real-time positional tracking system is achieved by placing the previously recorded holographic film over a light to electronic sensor like a CCD, CMOS, Photodiode array. The sensors measure the light from areas of the holographic film that relay an encoding of the pose of a remote laser source. The laser source can be the fixed reference point in this positional tracking system. By decoding the light patterns from the holographic film onto the sensor(s) the 1D, 2D or 3D pose of the remote laser source can be determined. In addition, polarization can be used to improve the robustness of the pose tracking or add a single axis of orientation (Azimuth, Bearing or Roll) tracking. A static polarizer on the laser source and on the holographic film can change the encoding patterns to portray additional information to aid the positional tracking.

Using the techniques herein, a positional tracking system can be constructed from a coherent laser source and holographic film placed over a light sensor, with software or hardware to decode the holographic patterns as positional and/or orientation tracking information. The laser source can operate in the infrared range and be invisible to the naked eye, as well as being modulated at a very high carrier frequency to be robust to noise from sunlight.

Accordingly, a method for recording a hologram of an array of position and/or orientation encodings (all examples of pose encodings) onto holographic film includes moving light from an encoding laser across plural position encoding object reflectors. At least some of the reflectors emit patterns of the light differently from each other to establish respective coded emissions. The method includes receiving each of the coded emissions from the reflectors on respective regions of the film, and correlating the coded emissions to respective positions of a laser.

In some implementations, the method can include illuminating the film using at least one indicator laser, juxtaposing the film with at least one sensor to sense light from areas of the film illuminated by the indicator laser and representing at least one of the coded emissions, and decoding signals from the sensor representing the at least one coded emission to return a respective position of a laser. In such embodiments, the position (and if desired other pose information) of a laser returned from decoding the signals is a position of the indicator laser, which may be an IR laser. Light from the indicator laser can be modulated at a carrier frequency of at least one megahertz.

In some embodiments the position encoding object reflectors establish plural different splotches, plural different lines, plural different bar codes, and plural different quick response (QR) codes.

In another aspect, an apparatus includes at least one indicator laser and at least one holographically recorded film having plural coded regions, with each coded region representing a code different from other coded regions on the film. At least one sensor is provided to sense light from at least one coded region of the film illuminated by the indicator laser. Also, at least one decoder is configured for decoding signals from the sensor representing the at least one coded region to return a respective position, orientation, or other pose information of the indicator laser.

In another aspect, an apparatus includes at least one holographically recorded film having plural coded regions. Each coded region represents a code different from other coded regions on the film. At least one data storage medium correlates the coded regions to respective positions of a laser. Alternatively or in addition, a circuit such as but not limited to an application specific integrated circuit (ASIC) may be provided for decoding information in the coded regions to render an output representing the pose information of the laser.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an encoding laser in a first pose, illuminating a first coded reflector;

FIGS. 2-5 are schematic views of various types of example robust codes that can be established by the reflectors shown in FIG. 1;

FIG. 6 is a block diagram of the encoding laser in a second pose, illuminating a second coded reflector, with the motor and mechanism for moving the laser removed for clarity;

FIG. 7 schematically illustrates a data structure that correlates laser positions to specific codes;

FIG. 8 is a block diagram of an encoding laser in a reflective configuration;

FIG. 9 is a block diagram of an illuminator such as an IR laser illuminating the holographic film with emissions from the film being detected by a sensor;

FIG. 10 is a flow chart of example logic for establishing the robust codes on the holographic film;

FIG. 11 is a flow chart of example logic for reading the codes on the film;

FIG. 12 is a schematic diagram showing a first use case in which the illuminator is fixed and the film/sensor assembly can move;

FIG. 13 is a schematic diagram showing a second use case in which the illuminator can move and the film/sensor assembly is fixed;

FIG. 14 illustrates that the object bearing the film/substrate assembly can be a hand-held game controller;

FIG. 15 illustrates that the object bearing the film/substrate assembly can be a glasses-like headset, schematically showing the illuminator with a light pipe; and

FIG. 16 is a block diagram of an example system including an example in accordance with present principles.

### DETAILED DESCRIPTION

This disclosure relates generally to computer ecosystems including aspects of consumer electronics (CE) device networks such as but not limited to computer game networks. A system herein may include server and client components, connected over a network such that data may be exchanged between the client and server components. The client components may include one or more computing devices including game consoles such as Sony PlayStation® or a game console made by Microsoft or Nintendo or other manufacturer virtual reality (VR) headsets, augmented reality (AR) headsets, portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

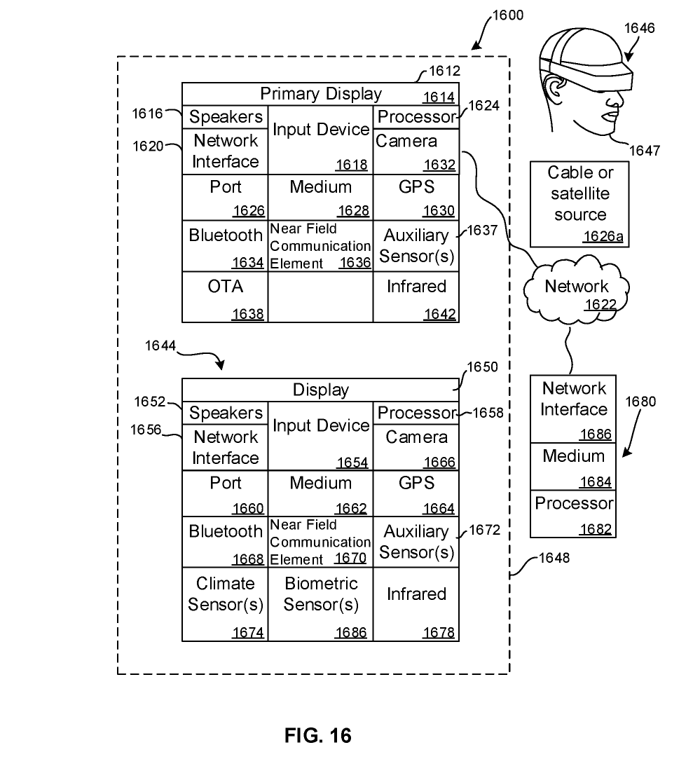

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members. FIG. 16 described below provides example components that may be used herein in the appropriate combinations.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/ or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to Java, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

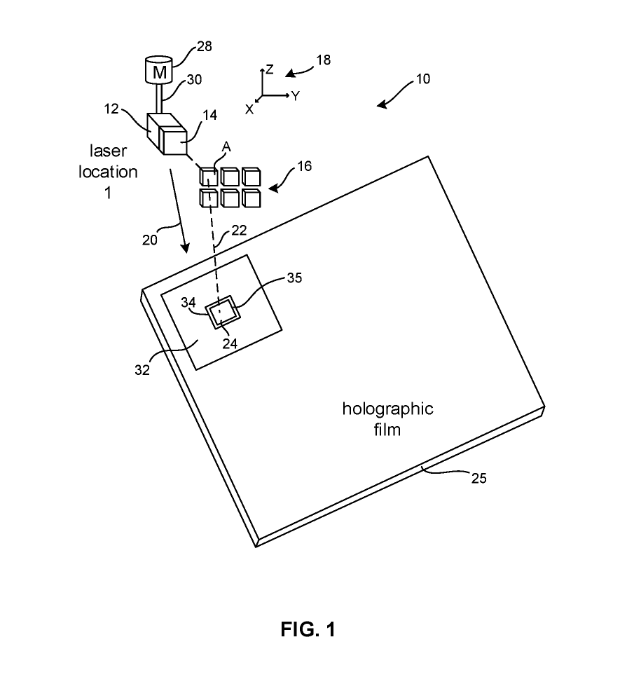

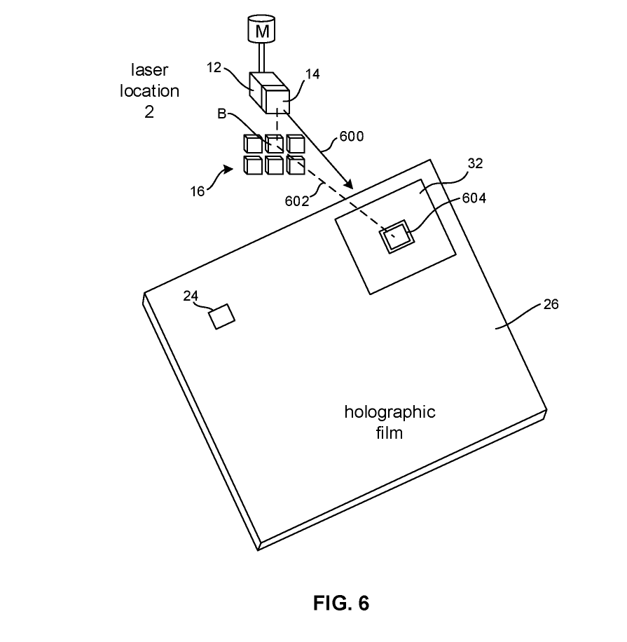

FIG. 1 illustrates a system 10 that includes one or more encoding lasers 12 that may emit light through one or more adjustable polarizers 14 such as polarization filters onto a selected reflector A in an array 16 of reflectors. As shown in FIGS. 1 and 6, in the example transmissive system the laser is on the same side of the holographic film discussed below as are the reflectors, Each reflector may deflect light including by way of internal reflection or refraction. As discussed more fully below, each reflector (or a group of reflectors when simultaneously illuminated by the laser) may establish a pattern of light deflection that creates a robust code.

In the example shown the array 16 is a two dimensional array but could be a three dimensional array as shown by the x-y-z axes 18. Light 20 from the encoding laser 12 that does not impinge on a reflector can interfere with light 22 that passes through a reflector, with the resulting interference pattern being encoded in a region 24 of a holographic film 26. Once illumination of a first reflector “A” is encoded onto the region 24 of the film 26, a motor 28 that is coupled to the encoding laser 12 by a mechanism 30 (such as a gimbal, servo, rail, rack-and-pinion, etc.) can be activated to move the encoding laser 12 to illuminate another one of the reflectors in the array, with each reflector (or groups of reflectors when simultaneously illuminated) establishing its own unique code. If desired, reflectors that are not to be illuminated for a particular location of the encoding laser 12 can be masked by, for example, a movable physical mask (not shown for clarity) with a single opening placed over the reflector sought to be illuminated and with a mask substrate that blocks light from other reflectors. A similar movable mask 32 can also be formed with an opening 34 and positioned over the region 24 during encoding to mask other nearby regions, reducing cross-talk. A polarization filter 35 may be disposed in the opening 34 if desired. Motors and mechanisms similar to those used to move the laser can be used to move the mask(s). Various other mechanisms can be utilized for masking the exposure for the areas outside of region 24, including but not limited to a LCD polarizing screen and other forms of dynamic light blocking schemes.

Note that the polarization filters herein may be altered spatially for the hologram recording to reduce cross-talk with neighboring encoding areas on the holographic film. The polarization can be dynamic by using an electronically controlled spatial light modulator in addition to or in lieu of the polarizer 14.

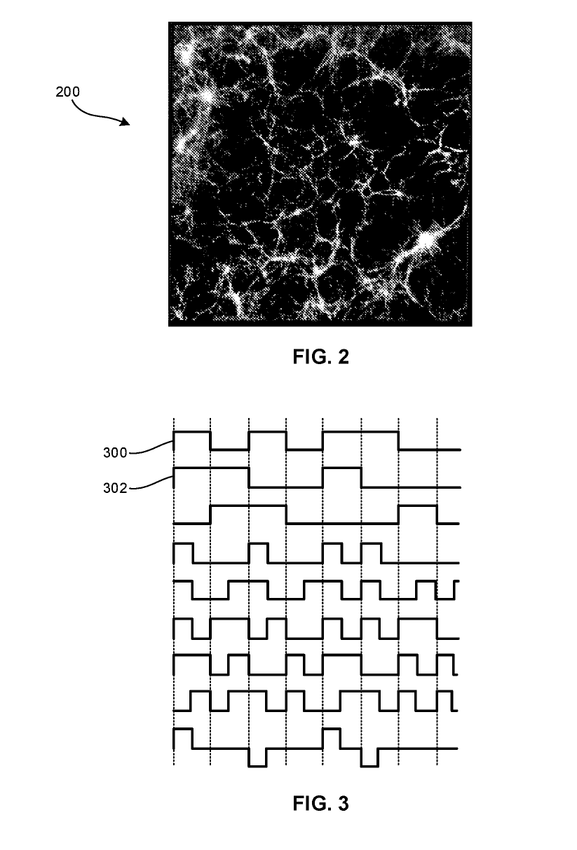

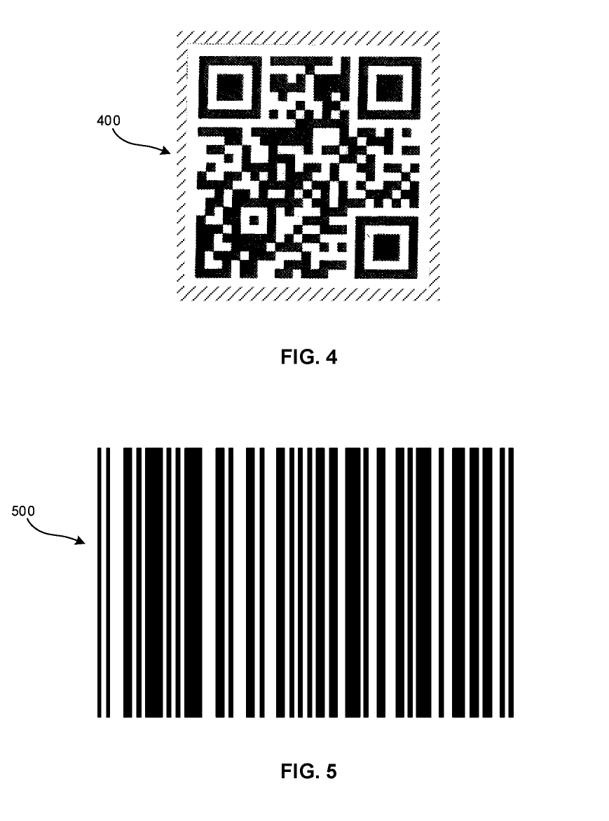

Prior to further explanation of present techniques, reference is directed to FIGS. 2-5, which illustrate various non-limiting examples of robust unique codes that can be established by each reflector in the array and encoded in its own respective region of the film 26. FIG. 2 shows a single “splotch” 200 with a unique configuration. Each reflector in the array 16 may encode its own respective splotch. FIG. 3 shows a series of unique linear codes, e.g., first and second codes 300, 302 that can be established by respective reflectors. FIG. 4 illustrates that each unique code may be a quick response (QR) code 400, while FIG. 5 shows that each unique code may be a bar code 500. Combinations of the codes in FIGS. 2-5 may be used. Thus, each reflector may be configured with its own unique code printed, etched, or otherwise formed on it.

In FIGS. 1 and 6, the location (also referred to herein as “position”) the encoding laser 12 is in with respect to the film 26 when irradiating the reflector “A” to encode the interference pattern in the region 24 is recorded, along with the unique code established by the reflector. The location can include the location in one, two, or three dimensions, and may also include the orientation (line-of-sight angle) of the encoding laser 12 with respect to the film 26 as discussed above (all examples of “pose” information), and the polarization used to encode the region 24.

Once the region 24 has encoded the unique pattern from the reflector A, the encoding laser 12 is moved one increment to a next nearest location as shown in FIG. 6 (with the mask 32 being correspondingly moved as shown) and activated to irradiate a second reflector “B” in the array 16. The angle of irradiation/orientation of reflector B may be established, if desired, such that the resulting interference pattern from the direct beam 600 and deflected beam 602 is encoded in a second region 604 that is significantly distanced from the first region 24. In the example shown, while the first and second regions encode respective unique codes that are associated with respective laser locations that are only a single increment of location recording apart, they may be physically separated from each other by regions of the film 26 that encode other codes associated with other laser locations. Also, successive reflectors in the array 16 may be irradiated with respective different polarizations. In this way, when the film 26 subsequently is used to determine the location of an illuminating laser with respect to a detector as described more fully below, discrimination of the precise location of the laser is made more robust by reducing the possibility of cross-talk. The reflector B is illuminated and its code recorded along with the location of the laser during illumination. It may now be appreciated that for each of multiple laser locations with respect to the film, an individual (or individual group of) reflectors in the array is illuminated to encode its unique code on a region of the film, the laser is moved, another reflector illuminated to encode another unique code in a different region of the film, and so on, with each laser location (pose information) being recorded if desired against the code of the reflector that was used for that laser location.

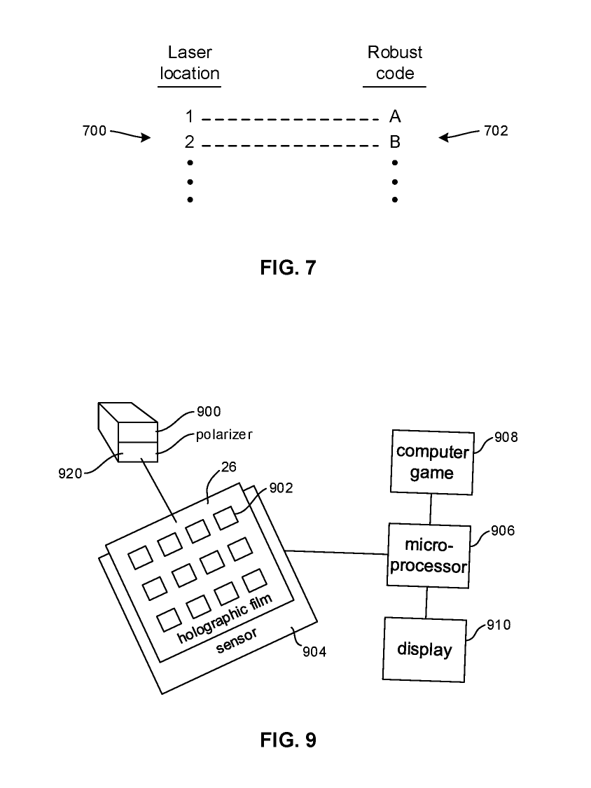

FIG. 7 shows an example data structure that may be recorded on, e.g., disk-based or solid state memory in which laser locations in a first column 700 are correlated with respective robust codes in a column 702, for purposes to be shortly disclosed.

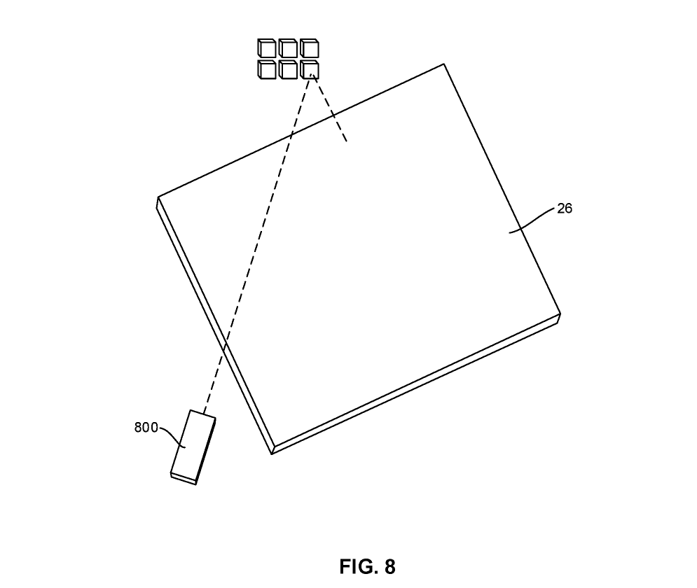

While FIGS. 1 and 6 show a transmissive system, FIG. 8 shows that a laser 800 may be used to sequentially irradiate each of a series of reflectors 802 in a reflective arrangement to encode the respective codes onto the film 26. In the arrangement of FIG. 8, the laser is on the opposite side of the film from the reflectors. Note that the sensor in FIG. 9 described below may be positioned on either side of the holographic film regardless of whether the hologram was encoded using transmissive or reflective principles.

It may now be appreciated that once the film 26 has been encoded as described above, when another laser (referred to herein as an “indicator” laser) subsequently illuminates the film, the indicator laser will illuminate the region of film that was encoded by the encoding laser 12 when the encoding laser 12 was in the same relative location to the film 26 as the subsequent indicator laser is in. FIG. 9 illustrates an indicator laser 900 (with adjustable polarizer not shown) illuminating one of plural encoded regions 902 on the film 26, with each region 902 encoding a unique robust code that is correlated to a respective location of the laser as described above. A sensor 904 such as but not limited to a charge-coupled device (CCD), complementary metal-oxide semiconductor (CMOS) detector, or photodiode array detector senses laser light emitted from the film 26 (and, hence, the unique code of the region 902 that is illuminated) and sends a signal representative thereof to one or more decoders such as one or more processors 906. The processor 906 can execute image recognition to determine which unique code is received, and access the data structure shown in FIG. 7 to correlate the code to a location of the indicator laser 900 with respect to the film 26. The processor 906 may execute a software-based computer game 908 and output demanded images from the game 908 onto a display 910, with game execution (and, hence, the demanded images) using, if desired, the laser location to alter the game images. This is amplified on further below.

The indicator laser 900 may be an infrared (IR) laser, although other wavelengths including visible and ultraviolet are contemplated. In some embodiments the wavelength of the light emitted by the indicator laser 900 may be greater than 1,000 nanometers, e.g., 1,440 nm to ensure that a game player does not see the laser light. The laser may be pulsed using a pulse repetition rate (PRR) that uniquely identifies the laser from other nearby indicator lasers. The laser may be modulated at a very high carrier frequency, e.g., in excess of thirty kilohertz, more preferably in excess of fifty kilohertz, and more preferably still at least one megahertz to be robust to noise from sunlight.

If desired, light from the indicator laser 900 can be polarized and changed over time using a polarizer 920 to improve signal to noise ratio of encoding. In this way, a plurality of signals can be decoded for each temporal polarization and the encoding with the highest signal to noise ratio may be chosen.

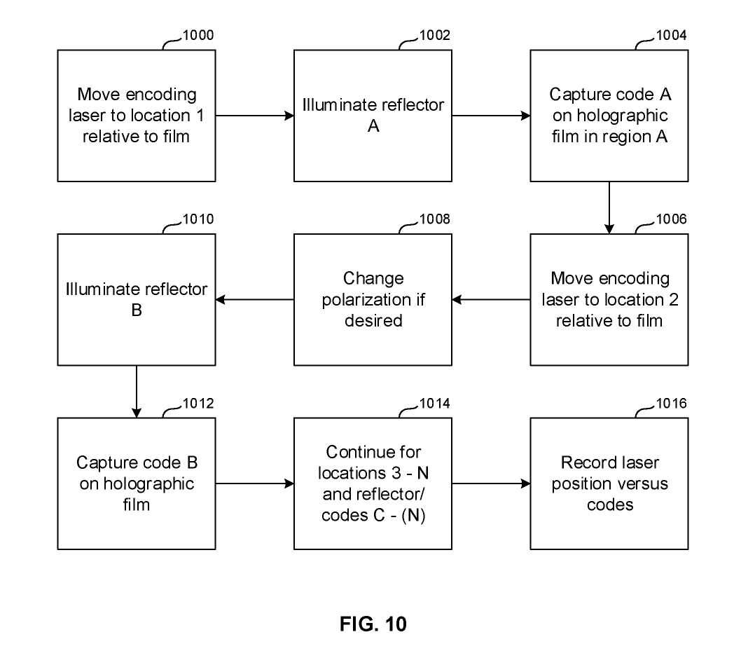

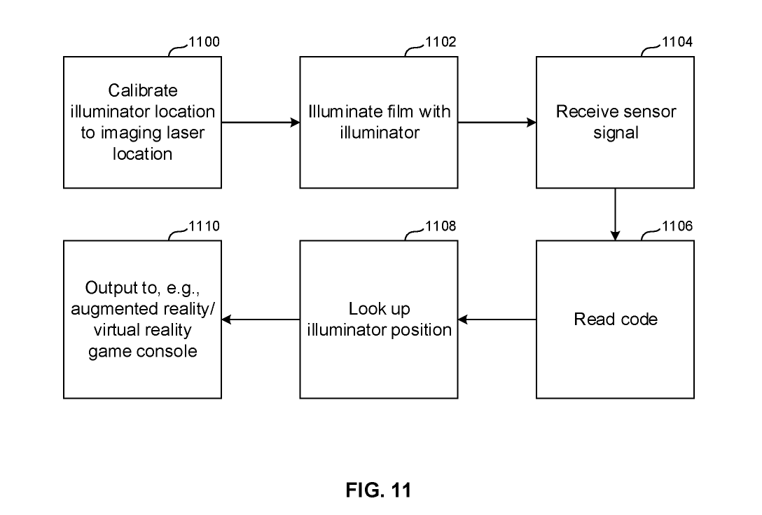

FIG. 10 shows the logic of the encoding technique described above while FIG. 11 shows the logic of the subsequent location determination technique, with some or all of the logic steps being controlled by any of the processors described herein. Commencing at block 1000, the encoding laser 12 is moved to a first location relative to the film 26 and activated to illuminate a first reflector A at block 1002. The code is captured or encoded at block 1004 on the holographic film 26 in a first region A of the film (region 24 in FIGS. 1 and 6).

Proceeding to block 1006 the encoding laser 12 is moved to the next location relative to the film 12, and if desired its polarization is changed at block 1008 for reasons explained above. A second reflector B is illuminated by the laser at block 1010 and its code captured (encoded) in the film 26 at block 1012. The described process of moving the encoding laser, changing polarization if desired, and successively illuminating reflectors continues at block 1014 for subsequent locations 3, . . . N to encode subsequent respective unique reflector codes C, . . . N onto the film 26, with each code being recorded and correlated to the respective location information of the laser 12 at block 1016.

Recalling the subsequent location determination system of FIG. 9 and turning now to related FIG. 11, at block 1100, if desired the indicator laser 900 is calibrated to a location relative to the film 26 to approximate that of the encoding laser 12 in the earlier encoding process. This may be done, e.g., by instructing a user or installer to mount the indicator laser at a certain point or location, e.g., on the top middle of a display on which a computer game is to be displayed. This reference location may be supplied to a computer game so that subsequent locations of game objects as described below, for example, can be known relative to the reference location. That is, a game designer can assume, for instance, that any locations dynamically received during game play can be assumed to be referenced to a particular physical location on the game display, as but one example.

Proceeding to block 1102, the film 26 is illuminated with the indicator laser 900. The sensor 904 senses the resultant unique robust code pattern of light emitted from the film and its signal representative thereof is received at block 1104. Image recognition is applied to the signal to recognize the code at block 1106. In one example, the recognized code can be used at block 1108 as entering argument to, e.g., the data structure of FIG. 7 to return the corresponding location of the laser 900 with respect to the film. In another implementation, the correlation from coded region to pose information can be undertaken algorithmically/mathematically without a data storage medium holding a database of values. For example, a binary encoding scheme could directly store the binary representation of the pose information values, e.g., if X Code blocks: 1101=X=13. In an example implementation, a circuit such as but not limited to a simple ASIC attached to the sensor 904 decodes the binary encoding of a recognized code efficiently and outputs it out as an analog (voltage) or digital value (SPI or other interface) for the pose value. No additional host processing is required.

In any case, however derived from the code, the pose information including location of the laser may be output at block 1110 to an AR or VR computer game console for reasons to be shortly illuminated.

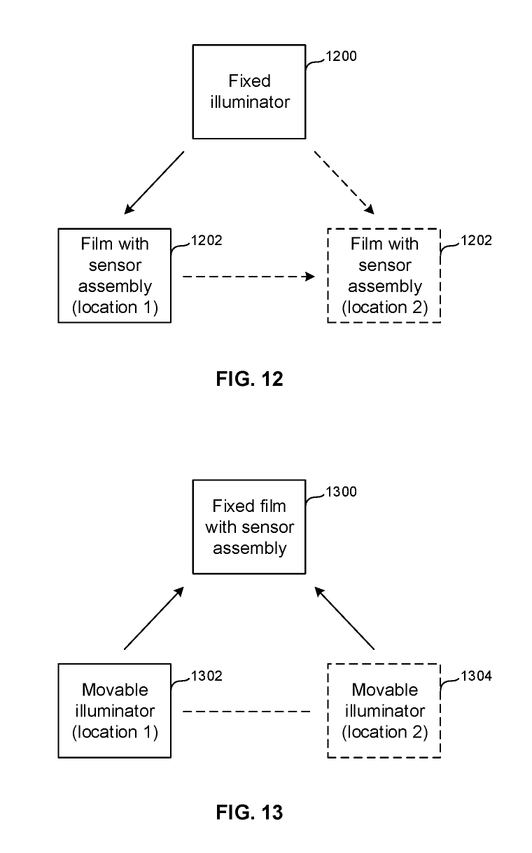

More specifically and turning to FIG. 12 for a first example arrangement for applying the system of FIGS. 9 and 11, an architecture is shown in which a fixed illuminator 1200 such as the indicator laser 900 can illuminate one or more assemblies 1202 that are movable. Each assembly 1202 may include a film such as the holographic film 26 and a sensor such as the sensor 904. Because the laser locations correlated to the robust codes on the film are relative locations between the laser and film, the codes that are illuminated when an assembly 1202 moves relative the fixed illuminator 1200 indicate the respective relative locations of the assemblies 1202 with respect to the fixed illuminator 1200. Thus, as the assembly 1202 moves from location 1 in FIG. 12 to location 2, the regions of the film in the assembly that are illuminated change from a first region to a second region, meaning that the sensor in the assembly senses one robust code at location 1, which is correlated to the first location, and another robust code at location 2, which is correlated to a second location.

Note that plural fixed illuminators 1200 may be used in a system, each using a unique PRR as indicated above. If desired, each fixed illuminator may be associated with a respective fixed sensor 904 with film 26 assembly, and each illuminator with its sensor and film, in a fixed assembly, can be aware of other fixed illuminator assemblies. This allows multiple illuminators to self-calibrate, enabling a single tracking space.

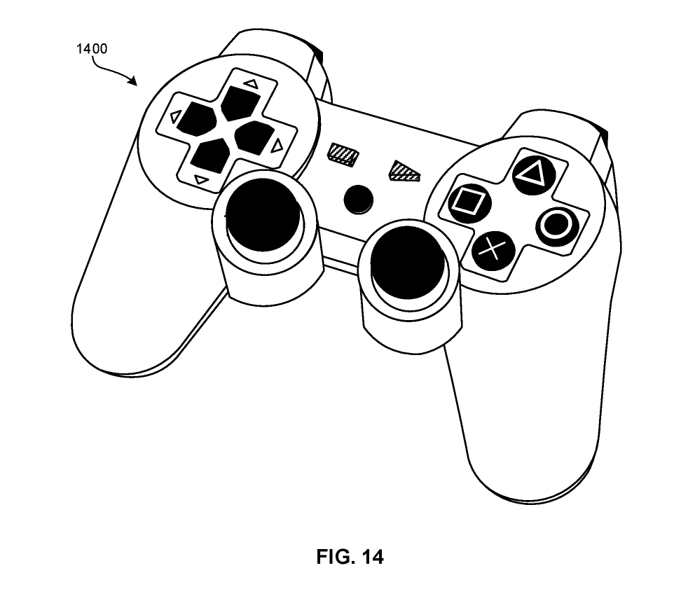

Alternatively and again because the recorded locations in FIG. 7 are relative between the film and laser, if desired an architecture as in FIG. 13 may be used, in which an assembly 1300 with the film 26 and sensor 904 is fixed and an illuminator such as the indicator laser 900 can move from a first location 1302 to a second location 1304, with the locations 1302, 1304 being derived from the codes on the illuminated film in the fixed assembly 1300.

Assuming the architecture of FIG. 12, the movable film/sensor assembly 1202 may be implemented by a VR or AR headset such as the one shown in FIG. 16 and described further below. A single headset may include multiple assemblies 1202 that can be illuminated by one fixed indicator laser 900 or by plural respective indicator lasers. Since the arrangement of plural film/sensor assemblies on a headset is known, their relative locations with respect to each other also are known.

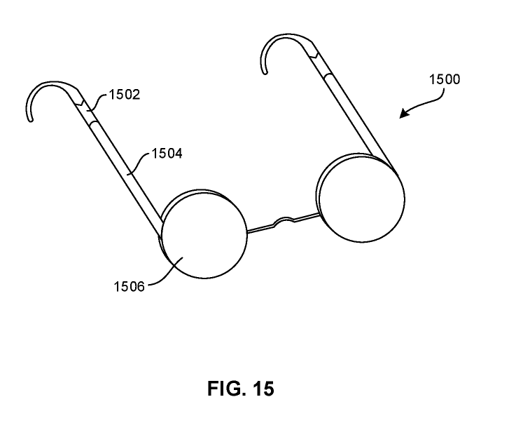

Or, the movable film/sensor assembly 1202 may be implemented by a game controller such as the controller 1400 shown in FIG. 14. Yet again, the movable film/sensor assembly 1202 may be implemented by an eyeglasses-type frame 1500 (FIG. 15). A laser 1502 may be mounted in the frame and a light pipe 1504 may be used to direct laser light onto glasses-type displays 1506.

In any case, it may now be appreciated that the locations of objects such as but not limited to the movable game-related objects described herein can be ascertained with respect to a reference point that can be tied to a computer game. Each movable film/sensor assembly 1202 can determine its location as described above and wirelessly report the location to the game processor. Or, the assembly can simply send a signal representing the unique code being illuminated to the game processor for derivation of the location by the game processor. Regardless, the game processor may then know, for example, the location of a VR/AR headset relative to the display on which the game is presented, and/or the location of the game controller 1400, etc. and tailor VR/AR presentation accordingly.

In some implementations, the encoded regions of the film 26 (e.g., the regions 24, 604) can be exposed to the encoding laser light multiple times to be reused. For example, the region 24 can be exposed for laser position X=0, Y=0 and again for laser position X=0, Y=1. This will allow fewer code blocks to be used for encoding. An example can use 2's complement unsigned binary encoding, where 2 code blocks=3 codes, 3 code blocks=7 codes, 4 code blocks=15 codes, etc.

As mentioned previously, temporally changing polarization of the encoding laser 12 (and subsequent decoding by the indicator laser 900) can be used to improve code block robustness. During the encoding phase, adjoining code blocks on the holographic film 26 may be recorded from differently polarized laser light to reduce cross-talk of laser light into adjoining code blocks. During the sensing phase, the laser light from the indicator laser 900 can be temporally polarized with differing polarizations. The successive polarizations over a short duration and subsequent lit code blocks will facilitate the code-to-position determination as one polarization on a specific code block (that was recorded with that polarization) will have a significantly higher signal-to-noise ratio (SNR) than other polarizations. This technique allows for improved filtering and detection of the correct position encoding code sequence.

Now referring to FIG. 16, an example system 1600 is shown, which may include one or more of the example devices mentioned below in accordance with present principles. The first of the example devices included in the system 1610 is a consumer electronics (CE) device such as an audio video device (AVD) 1612 such as but not limited to an Internet-enabled TV with a TV tuner (equivalently, set top box controlling a TV). However, the AVD 1612 alternatively may be an appliance or household item, e.g. computerized Internet enabled refrigerator, washer, or dryer. The AVD 1612 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVD 1612 is configured to undertake present principles (e.g. communicate with other CE devices to undertake present principles, execute the logic described herein, and perform any other functions and/or operations described herein).

Accordingly, to undertake such principles the AVD 1612 can be established by some or all of the components shown in FIG. 16. For example, the AVD 1612 can include one or more displays 1614 that may be implemented by a high definition or ultra-high definition “4K” or higher flat screen and that may be touch-enabled for receiving user input signals via touches on the display. The AVD 1612 may include one or more speakers 1616 for outputting audio in accordance with present principles, and at least one additional input device 1618 such as e.g. an audio receiver/microphone for e.g. entering audible commands to the AVD 1612 to control the AVD 1612. The example AVD 1612 may also include one or more network interfaces 1620 for communication over at least one network 1622 such as the Internet, an WAN, an LAN, etc. under control of one or more processors 1624 including. A graphics processor 1624A may also be included. Thus, the interface 1620 may be, without limitation, a Wi-Fi transceiver, which is an example of a wireless computer network interface, such as but not limited to a mesh network transceiver. It is to be understood that the processor 1624 controls the AVD 1612 to undertake present principles, including the other elements of the AVD 1612 described herein such as e.g. controlling the display 1614 to present images thereon and receiving input therefrom. Furthermore, note the network interface 1620 may be, e.g., a wired or wireless modem or router, or other appropriate interface such as, e.g., a wireless telephony transceiver, or Wi-Fi transceiver as mentioned above, etc.

In addition to the foregoing, the AVD 1612 may also include one or more input ports 1626 such as, e.g., a high definition multimedia interface (HDMI) port or a USB port to physically connect (e.g. using a wired connection) to another CE device and/or a headphone port to connect headphones to the AVD 1612 for presentation of audio from the AVD 1612 to a user through the headphones. For example, the input port 1626 may be connected via wire or wirelessly to a cable or satellite source 1626a of audio video content. Thus, the source 1626a may be, e.g., a separate or integrated set top box, or a satellite receiver. Or, the source 1626a may be a game console or disk player containing content that might be regarded by a user as a favorite for channel assignation purposes described further below. The source 1626a when implemented as a game console may include some or all of the components described below in relation to the CE device 1644.

The AVD 1612 may further include one or more computer memories 1628 such as disk-based or solid state storage that are not transitory signals, in some cases embodied in the chassis of the AVD as standalone devices or as a personal video recording device (PVR) or video disk player either internal or external to the chassis of the AVD for playing back AV programs or as removable memory media. Also in some embodiments, the AVD 1612 can include a position or location receiver such as but not limited to a cellphone receiver, GPS receiver and/or altimeter 1630 that is configured to e.g. receive geographic position information from at least one satellite or cellphone tower and provide the information to the processor 1624 and/or determine an altitude at which the AVD 1612 is disposed in conjunction with the processor 1624. However, it is to be understood that that another suitable position receiver other than a cellphone receiver, GPS receiver and/or altimeter may be used in accordance with present principles to e.g. determine the location of the AVD 1612 in e.g. all three dimensions.

Continuing the description of the AVD 1612, in some embodiments the AVD 1612 may include one or more cameras 2632 that may be, e.g., a thermal imaging camera, a digital camera such as a webcam, and/or a camera integrated into the AVD 1612 and controllable by the processor 1624 to gather pictures/images and/or video in accordance with present principles. Also included on the AVD 1612 may be a Bluetooth transceiver 1634 and other Near Field Communication (NFC) element 1636 for communication with other devices using Bluetooth and/or NFC technology, respectively. An example NFC element can be a radio frequency identification (RFID) element.

Further still, the AVD 1612 may include one or more auxiliary sensors 1637 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 1624. The AVD 1612 may include an over-the-air TV broadcast port 1638 for receiving OTA TV broadcasts providing input to the processor 1624. In addition to the foregoing, it is noted that the AVD 1612 may also include an infrared (IR) transmitter and/or IR receiver and/or IR transceiver 1642 such as an IR data association (IRDA) device. A battery (not shown) may be provided for powering the AVD 1612.

Still referring to FIG. 16, in addition to the AVD 1612, the system 1600 may include one or more other CE device types. In one example, a first CE device 1644 may be used to send computer game audio and video to the AVD 1612 via commands sent directly to the AVD 1612 and/or through the below-described server while a second CE device 1646 may include similar components as the first CE device 1644. In the example shown, the second CE device 1646 may be configured as a VR headset worn by a player 1647 as shown. In the example shown, only two CE devices 1644, 1646 are shown, it being understood that fewer or greater devices may be used. For example, principles below discuss multiple players 1647 with respective headsets communicating with each other during play of a computer game sourced by a game console to one or more AVD 1612, as an example of a multiuser voice chat system. Note that each laser/illuminator assembly and each sensor/film assembly may incorporate one or more components of the CE device 1644 such as appropriate processors, computer storage, and communication

In the example shown, to illustrate present principles all three devices 1612, 1644, 1646 are assumed to be members of an entertainment network in, e.g., a home, or at least to be present in proximity to each other in a location such as a house. However, present principles are not limited to a particular location, illustrated by dashed lines 1648, unless explicitly claimed otherwise. Any or all of the devices in FIG. 16 can implement any one or more of the lasers, films, and sensors described previously.

The example non-limiting first CE device 1644 may be established by any one of the above-mentioned devices, for example, a portable wireless laptop computer or notebook computer or game controller (also referred to as “console”), and accordingly may have one or more of the components described below. The first CE device 1644 may be a remote control (RC) for, e.g., issuing AV play and pause commands to the AVD 1612, or it may be a more sophisticated device such as a tablet computer, a game controller communicating via wired or wireless link with the AVD 1612, a personal computer, a wireless telephone, etc.

Accordingly, the first CE device 1644 may include one or more displays 1650 that may be touch-enabled for receiving user input signals via touches on the display. The first CE device 1644 may include one or more speakers 1652 for outputting audio in accordance with present principles, and at least one additional input device 1654 such as e.g. an audio receiver/microphone for e.g. entering audible commands to the first CE device 1644 to control the device 1644. The example first CE device 1644 may also include one or more network interfaces 1656 for communication over the network 1622 under control of one or more CE device processors 1658. A graphics processor 1658A may also be included. Thus, the interface 1656 may be, without limitation, a Wi-Fi transceiver, which is an example of a wireless computer network interface, including mesh network interfaces. It is to be understood that the processor 1658 controls the first CE device 1644 to undertake present principles, including the other elements of the first CE device 1644 described herein such as e.g. controlling the display 1650 to present images thereon and receiving input therefrom. Furthermore, note the network interface 1656 may be, e.g., a wired or wireless modem or router, or other appropriate interface such as, e.g., a wireless telephony transceiver, or Wi-Fi transceiver as mentioned above, etc.

In addition to the foregoing, the first CE device 1644 may also include one or more input ports 1660 such as, e.g., a HDMI port or a USB port to physically connect (e.g. using a wired connection) to another CE device and/or a headphone port to connect headphones to the first CE device 1644 for presentation of audio from the first CE device 1644 to a user through the headphones. The first CE device 1644 may further include one or more tangible computer readable storage medium 1662 such as disk-based or solid state storage. Also in some embodiments, the first CE device 1644 can include a position or location receiver such as but not limited to a cellphone and/or GPS receiver and/or altimeter 1664 that is configured to e.g. receive geographic position information from at least one satellite and/or cell tower, using triangulation, and provide the information to the CE device processor 1658 and/or determine an altitude at which the first CE device 1644 is disposed in conjunction with the CE device processor 1658. However, it is to be understood that that another suitable position receiver other than a cellphone and/or GPS receiver and/or altimeter may be used in accordance with present principles to e.g. determine the location of the first CE device 1644 in e.g. all three dimensions.

Continuing the description of the first CE device 1644, in some embodiments the first CE device 1644 may include one or more cameras 1666 that may be, e.g., a thermal imaging camera, a digital camera such as a webcam, and/or a camera integrated into the first CE device 1644 and controllable by the CE device processor 1658 to gather pictures/images and/or video in accordance with present principles. Also included on the first CE device 1644 may be a Bluetooth transceiver 1668 and other Near Field Communication (NFC) element 1670 for communication with other devices using Bluetooth and/or NFC technology, respectively. An example NFC element can be a radio frequency identification (RFID) element.

Further still, the first CE device 1644 may include one or more auxiliary sensors 1672 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 1658. The first CE device 1644 may include still other sensors such as e.g. one or more climate sensors 1674 (e.g. barometers, humidity sensors, wind sensors, light sensors, temperature sensors, etc.) and/or one or more biometric sensors 1676 providing input to the CE device processor 1658. In addition to the foregoing, it is noted that in some embodiments the first CE device 1644 may also include an infrared (IR) transmitter and/or IR receiver and/or IR transceiver 1678 such as an IR data association (IRDA) device. A battery (not shown) may be provided for powering the first CE device 1644. The CE device 1644 may communicate with the AVD 1612 through any of the above-described communication modes and related components.

The second CE device 1646 may include some or all of the components shown for the CE device 1644. Either one or both CE devices may be powered by one or more batteries.

Now in reference to the afore-mentioned at least one server 1680, it includes at least one server processor 1682, at least one tangible computer readable storage medium 1684 such as disk-based or solid state storage, and at least one network interface 1686 that, under control of the server processor 1682, allows for communication with the other devices of FIG. 16 over the network 1622, and indeed may facilitate communication between servers and client devices in accordance with present principles. Note that the network interface 1686 may be, e.g., a wired or wireless modem or router, Wi-Fi transceiver, or other appropriate interface such as, e.g., a wireless telephony transceiver.

Accordingly, in some embodiments the server 1680 may be an Internet server or an entire server “farm”, and may include and perform “cloud” functions such that the devices of the system 1600 may access a “cloud” environment via the server 1680 in example embodiments for, e.g., network gaming applications. Or, the server 1680 may be implemented by one or more game consoles or other computers in the same room as the other devices shown in FIG. 16 or nearby.

The methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a CD ROM or Flash drive. The software code instructions may alternatively be embodied in a transitory arrangement such as a radio or optical signal, or via a download over the internet.

It will be appreciated that whilst present principals have been described with reference to some example embodiments, these are not intended to be limiting, and that various alternative arrangements may be used to implement the subject matter claimed herein.

What is claimed is:

1. A method for recording a hologram of an array of pose information encodings onto holographic film, comprising:
moving light from an encoding laser across plural pose encoding object reflectors, at least some of the reflectors emitting patterns of the light differently from each other to establish respective coded emissions;
receiving each of the coded emissions from the reflectors on respective regions of the film; and
correlating the coded emissions to respective pose information of a laser.

2. The method of claim 1, comprising:
illuminating the film using at least one indicator laser;
juxtaposing the film with at least one sensor to sense light from areas of the film illuminated by the indicator laser and representing at least one of the coded emissions; and
decoding signals from the sensor representing the at least one coded emission to return a respective pose information of a laser.

3. The method of claim 1, wherein the pose information encoding object reflectors establish plural different splotches.

4. The method of claim 1, wherein the pose information encoding object reflectors establish plural different lines.

5. The method of claim 1, wherein the pose information encoding object reflectors establish plural different bar codes.

6. The method of claim 1, wherein the pose information encoding object reflectors establish plural different quick response (QR) codes.

7. The method of claim 2, wherein the pose information of a laser returned from decoding the signals indicates a position of the indicator laser.

8. The method of claim 1, wherein the pose information includes orientation of the laser.

9. The method of claim 2, wherein the light from the indicator laser is infrared (IR).

10. The method of claim 1, wherein light from the indicator laser is modulated at a carrier frequency of at least 50 khz.

11. The method of claim 1, comprising polarizing light from the encoding laser to improve signal to noise ratio of encoding.

12. The method of claim 11, where polarization of the light from the encoding laser is established by a first static polarization filter associated with the encoding laser.

13. The method of claim 12, comprising providing a second polarization filter associated with the holographic film.

14. The method of claim 13, comprising spatially altering the first and second polarization filters for the hologram recoding to reduce cross-talk with neighboring encoding areas on the holographic film.

15. The method of claim 12, wherein the polarization is dynamic by an electronically controlled spatial light modulator.

16. The method of claim 1, comprising masking the light from the encoding laser using at least one mask to reduce an exposure area on the holographic film to a specific encoding region during hologram recording.

17. The method of claim 16, comprising moving the at least one mask during hologram encoding to reduce cross-talk with neighboring encoding areas on the holographic film.

18. The method of claim 2, comprising temporarily polarizing light from the indicator laser.

19. The method of claim 18 comprising decoding a plurality of signals for each temporal polarization of light from the indicator laser and selecting a first signal from among the plurality of signals responsive to the first signal having a signal to noise ratio higher than any other signal in the plurality of signals.

20. An apparatus, comprising:
at least one indicator laser;
at least one holographically recorded film having plural coded regions, each coded region representing a code different from other coded regions on the film;
at least one sensor to sense light from at least one coded region of the film illuminated by the indicator laser; and
at least one decoder configured for decoding signals from the sensor representing at least one coded region to return a respective pose information of the indicator laser.

21. The apparatus of claim 20, wherein the codes comprise respective plural different splotches.

22. The apparatus of claim 20, wherein the codes comprise respective plural different lines.

23. The apparatus of claim 20, wherein the codes comprise respective plural different bar codes.

24. The apparatus of claim 20, wherein the codes comprise respective plural different quick response (QR) codes.

25. The apparatus of claim 20, wherein the light from the indicator laser is infrared (IR).

26. The apparatus of claim 20, wherein light from the indicator laser is modulated at a carrier frequency of at least 50 khz

27. The apparatus of claim 20, comprising an encoding laser establishing the codes in the coded regions and at least one polarizer polarizing light from the encoding laser to improve signal to noise ratio of encoding.

28. The apparatus of claim 27, wherein polarization of light from the encoding laser is established by a first static polarization filter associated with the encoding laser.

29. The apparatus of claim 28, comprising a second polarization filter associated with the holographic film.

30. The apparatus of claim 29, wherein the first and second polarization filters are altered spatially for the hologram recoding to reduce cross-talk with neighboring encoding areas on the holographic film.

31. The apparatus of claim 27, wherein polarization of light from the encoding laser is dynamically established by an electronically controlled spatial light modulator.

32. The apparatus of claim 27, comprising at least one mask configured for masking the light from the encoding laser to reduce an exposure area on the holographic film to a specific encoding region during hologram recording.

33. The apparatus of claim 32, wherein the mask is movable during hologram encoding to reduce cross-talk with neighboring encoding areas on the holographic film.

34. The apparatus of claim 20, wherein light from the indicator laser is temporally polarized to improve signal to noise ratio of decoding.

35. The apparatus of claim 34, comprising a decoder for decoding a plurality of signals for each temporal polarization of light from the indicator laser and for selecting a first signal from among the plurality of signals responsive to the first signal having a signal to noise ratio higher than any other signal in the plurality of signals.

36. An apparatus, comprising:
at least one holographically recorded film having plural coded regions, each coded region representing a code different from other coded regions on the film; and
at least one data storage medium correlating the coded regions to respective pose information of a laser, and/or at least one circuit for decoding information in the coded regions to render an output representing the pose information of the laser.

37. The apparatus of claim 36, comprising:
at least one indicator laser;
at least one sensor to sense light from at least one coded region of the film illuminated by the indicator laser; and
at least one decoder configured to decode signals from the sensor representing the at least one coded region to return a respective pose information of the indicator laser.

38. The apparatus of claim 37, wherein the light from the indicator laser is infrared (IR).

39. The apparatus of claim 37, wherein light from the indicator laser is modulated at a carrier frequency of at least 50 khz

40. The apparatus of claim 36, comprising an encoding laser establishing the codes in the coded regions and at least one polarizer polarizing light from the encoding laser to improve signal to noise ratio of encoding.

41. The apparatus of claim 40, wherein polarization of light from the encoding laser is established by a first static polarization filter associated with the encoding laser.

42. The apparatus of claim 41, comprising a second polarization filter associated with the holographic film.

43. The apparatus of claim 42, wherein the first and second polarization filters are altered spatially for the hologram recoding to reduce cross-talk with neighboring encoding areas on the holographic film.

44. The apparatus of claim 40, wherein polarization of light from the encoding laser is dynamically established by an electronically controlled spatial light modulator.

45. The apparatus of claim 40, comprising at least one mask configured for masking the light from the encoding laser to reduce an exposure area on the holographic film to a specific encoding region during hologram recording.

46. The apparatus of claim 45, wherein the mask is movable during hologram encoding to reduce cross-talk with neighboring encoding areas on the holographic film.

47. The apparatus of claim 36, wherein light from the indicator laser is temporally polarized to improve signal to noise ratio of decoding.

48. The apparatus of claim 47, comprising a decoder for decoding a plurality of signals for each temporal polarization of light from the indicator laser and for selecting a first signal from among the plurality of signals responsive to the first signal having a signal to noise ratio higher than any other signal in the plurality of signals.

49. The method of claim 1, comprising pulsing light from the indicator laser at a pulse repetition rate (PRR) that uniquely identifies the indicator laser and/or a manufacturer of the indicator laser.

50. The apparatus of claim 20, wherein light from the indicator laser is pulsed at a pulse repetition rate (PRR) that uniquely identifies the indicator laser and/or a manufacturer of the indicator laser.

51. The apparatus of claim 37, wherein light from the indicator laser is pulsed at a pulse repetition rate (PRR) that uniquely identifies the indicator laser and/or a manufacturer of the indicator laser.
